(19) United States
(12) Patent Application Publication
(10) Pub. No.: US 2009/0107584 A1
(43) Pub. Date: Apr. 30, 2009

(54) SOLDER AND METHODS OF MAKING SOLDER

(75) Inventors: SUVANKAR SENGUPTA, Hilliard, OH (US); Ramachandra R. Revur, Columbus, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: NanoDynamics, Inc., Buffalo, NY (US)

(21) Appl. No.: 12/240,614

(22) Filed: Sep. 29, 2008

Related U.S. Application Data
(60) Provisional application No. 60/975,753, filed on Sep. 27, 2007.

(51) Int. Cl. B23K 35/34; B22F 9/16

(52) U.S. Cl. 148/24; 75/351

(57) ABSTRACT

Solder compositions and methods of forming solders are provided. The solder compositions exhibit desirable melting characteristics. In addition, the solder compositions may be useful in joining heat sensitive components such as sensors, system-in-package, memory, and MEMS devices.

### CROSS REFERENCE TO RELATED APPLICATIONS

This application claims priority to and any other benefit of U.S. Provisional Application Ser. No. 60/975,753, the entirety of which is incorporated by reference herein.

### BACKGROUND

The permanent attachment of metal components to one another is commonly accomplished by soldering or brazing, wherein a molten metal or alloy that wets the surfaces of both components is brought into contact with both components and then allowed to solidify. Where the components are delicate and subject to being damaged by high temperatures, there is a need for alloy solders that melt at relatively low temperatures. In particular, the soldering of thermally sensitive integrated circuits and other semiconductor devices to circuit boards and other electrical components requires low-melting alloy solders. Constant progress in reducing the size of such components has increased their susceptibility to thermal damage, and created a need for even lower-melting solder compositions.

Solder alloys are characterized by melting temperatures that are functions of composition. While a pure element is characterized by a single melting point, the freezing and melting properties of alloys are more complex. The freezing point of an alloy is determined by the liquidus line, above which only a liquid phase can exist. The melting point of an alloy is determined by the solidus line, below which only a solid phase or phases can exist. In the region between these two lines, solid and liquid phases can co-exist, and the crystalline structure of a solder joint is dependent on the precise composition of the alloy and on the rate of cooling of the liquid alloy as it transitions through the liquidus line to the solidus line. In many cases soldering alloys are eutectics, that is, they are characterized by a eutectic point, where the liquidus and solidus lines meet, which is typically the lowest temperature at which all of the phases of the alloy begin to melt.

A common electronic solder consists of the eutectic alloy composition 63% tin (Sn) and 37% lead (Pb), which has a melting temperature of 183° C. The properties of this basic alloy can be modified by adding additional metals. For example, a lower-melting solder alloy (nominal composition Sn-41.75Pb-8Bi-0.5Ag) permits peak reflow temperatures of 166-172° C. during surface-mount assembly.

Lead is a toxic pollutant, however, and extensive efforts to reduce the presence of lead in electronic devices have led to the development of numerous lead-free solder alloys. Examples are tin (Sn), silver (Ag), and copper (Cu) alloys (“SAC alloys”) having concentrations of Sn, Ag, and Cu that approximate the ternary SAC eutectic. (The ternary eutectic SAC alloy composition is about 3.4 to 3.5% Ag, about 0.8 to 0.9% Cu, and the remainder Sn.) Typical commercial SAC alloy compositions comprise 3.8 to 4.0% Ag, 0.5 to 0.7% Cu, and the remainder Sn, optionally modified with trace amounts of additional elements such as bismuth or antimony. SAC alloy compositions near the ternary eutectic compositional range are candidates to replace the Sn-Pb alloy solder that has historically been used in electronic component assembly processes. The SAC ternary eutectic, however, melts at 217° C., which is considerably higher than alloys based on the Sn-Pb eutectic.

Solder paste is a homogenous, stable suspension of solder particles in a solder paste flux and has many applications in the electronics industry. For example, solder pastes may be useful in the manufacture of printed circuit boards (PCB) by reflow soldering, wherein electronic components are surface mounted on PCB to which a solder paste has previously been applied by a method such as screen printing or stenciling. The PCB is then subjected to a sufficiently high temperature, to cause the solder paste flux and the solder particles to liquefy and to join the components in place on the PCB. Solder pastes are also used in the preparation of ball grid arrays (BGA) and “flip-chip” solder bumps.

The solder paste flux improves the coalescence of the molten solder particles and the wetting of the metallic substrate, by removing oxide layers from the solder and joint surfaces and protecting the clean joint surfaces from oxidation until soldering has taken place. Solder paste flux also acts as a heat transfer medium, which ensures that all parts of the joint reach a temperature above the melting point of the solder particles.

There remains a need for solder compositions that melt at relatively low process temperatures and that are useful in a variety of applications.

### SUMMARY

In some embodiments, solder compositions and methods of making solder compositions are provided. In some embodiments, a solder composition comprises a plurality of metal particles, wherein the plurality of metal particles have an average diameter of less than about 100 nm and a flux, wherein the flux is selected such that the flux has at least one reactive group suitable for bonding with at least one the metal particles, and wherein at least one of the metal particles is bound to the flux.

In some embodiments, a method of making solder comprises providing a flux in a suitable solvent, wherein the flux is selected such that the flux has at least one reactive group; adding at least one meta l particle precursor to form a solution; and adding at least one reducing agent to the solution such that metal particles are formed and bonded to the flux, wherein the metal particles have an average diameter of less than about 100 nm.

### BRIEF DESCRIPTION OF THE SEVERAL VIEWS OF THE DRAWINGS

The following detailed description of embodiments of the present invention can be best understood when read in conjunction with the following drawings, where like structure is indicated with like reference numerals and in which:

FIG. 1 is a differential scanning calorimetry (DSC) plot of a solder composition having tin/silver/copper alloy particles obtained using 3 heating cycles to 300° C.;

FIG. 2 shows a DSC plot obtained using 4 cycles of heating to 210° C. with a 5 minute hold at temperature of a solder composition having tin/silver/copper alloy particles;

FIG. 3 shows a DSC plot obtained using 3 heating cycles to 300° C. of a solder composition having tin particles;

FIG. 4 shows a DSC plot obtained using 4 heating cycles to 210° C. with a 5 minute hold at temperature of a solder composition having tin particles; and

FIG. 5 shows a DSC plot obtained using 2 heating cycles to 300° C. and cooling down to 20° C. of a solder composition having tin alloy particles added to a flux.

### DETAILED DESCRIPTION OF EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In accordance with embodiments of the present invention, solder compositions and methods of forming solders are provided. The solder compositions exhibit desirable melting characteristics. In addition, the solder compositions may be useful in joining heat sensitive components such as sensors, system-in-package, memory, and MEMS devices.

In some embodiments, solder compositions comprising a plurality of metal particles having an average particle size of less than about 100 nm in the presence of a flux are provided. The flux is selected to provide dispersion and surface passivation of at least some of the plurality of metal particles.

The metal particles may be any suitable metal useful in solder compositions. For example, the metal particles may be tin, silver, bismuth, antimony, aluminum, and/or copper. In some examples, the metal particles are mixtures of metals provided in a desired ratio to form metal alloy particles. For example, the metal particles may be a tin/silver/copper alloy. In other examples, the metal particles may be bismuth/indium/tin alloys; bismuth/tin/antimony alloys; bismuth/tin/aluminum alloys; tin/bismuth alloys; tin/antimony alloys; tin/gold alloys; tin/indium alloys; and combinations thereof. It will further be understood that the alloys may be made with or without other minor alloying elements such as germanium or nickel. When a metal alloy is provided, it will be understood that the metal alloy components may be provided in any suitable ratio, and it will be further understood that one having skill in the art is able to select a metal alloy to target a suitable melting point and/or provide desired bonding characteristics. In some examples, the solder compositions are lead free compositions. The term “lead free” is used to denote a solder that is substantially free of lead. For example, a metal alloy in the solder composition with a concentration of lead in the alloy of less than about 0.1% by weight is considered lead free. It is understood that many metals, especially from the recycled metals source, may contain lead as a minor impurity.

The metal particles generally have an average diameter of less than about 100 nm. In some examples, the metal particles may be admixed with larger particles in excess of 100 nm in order to ensure efficient particle packing. In some examples, the metal particles have an average diameter of less than about 50 nm. In other examples, the metal particles have an average diameter of less than about 25 nm, less than about 20 nm, less than about 15 nm, less than about 10 nm, or less than about 5 nm.

In some examples, it is believed that the melting point relates to the particle size in accordance with the following expression:

Tₘ(r)=156.6−(220/r)

where Tₘ(r) is the melting temperature in degrees Centigrade and r is the radius of the particle in nanometers. Thus, the melting temperature of the solder composition can be controlled by providing metal particles having a suitable size, and those having skill in the art will be able to select suitable metal particles having suitable sizes for a desired melting point. Metal particles that are nano sized have high surface area and high surface energy versus particles of a larger size. These properties of nano sized metal particles lower the apparent melting point below the conventional melting point. For example, the melting points of tin, silver and copper can all be depressed below about 200° C., well below the eutectic melting point of a conventional tin, silver, and copper alloy solder of about 217° C.

The metal particles may be present in any suitable amount. For example, the metal particles may comprise from about 25 to about 95 percentage by weight of the solder composition. In some examples, the metal particles comprise about 29, about 80, about 85, about 90, about 91, or about 92 weight percent of the solder composition.

It will be understood that the solder compositions may have any suitable melting point. In some examples, the melting point of the solder compositions is less than about 200° C. In other examples, the melting point of the solder compositions is less than about 190° C. In yet further examples, the melting point of the solder compositions is below about 185° C., below about 180° C., below about 175° C., below about 170° C., or below about 165° C. In still further examples, a solder composition having tin particles may have a melting point of about 188° C., and a solder composition comprising a 96.5% tin/3% silver/0.5% Cu metal particle alloy may have a melting point of between about 177° C. and about 165° C. It is noted that the bulk melting point of bulk tin/silver/copper alloy is about 217° C., and the melting point of bulk tin is about 232° C.

Any suitable flux may be used. The term “flux” shall be understood as referring to any suitable flux that improves the coalescence of molten metal particles and that improves the wetting of a metallic substrate by removing or preventing oxide layers from forming on the metal particles and by protecting a clean metallic substrate from oxidation after application of the flux and before soldering, and it will be understood that the term “flux” includes heterogeneous and homogeneous compositions. Flux may also act as a heat transfer medium, and the heat transfer medium may help ensure that all parts of a joint reach a temperature above that of the melting point of the metal particles. In some examples, the flux is chosen to aid in dispersion and surface passivation of at least some of the metal particles. It will be understood that the flux may be a rosin flux. For example, the flux may be any of the rosin fluxes available from Indium Corporation. In some examples, the flux is at least one of Rosin 515-25, Rosin 541-70, and Rosin 541-71, available from Indium Corporation.

The flux may be present in any suitable amount. For example, the flux may be present in an amount of from about 5 to about 75 weight percent of the solder composition. For example, the flux may comprise about 71, about 20, about 15, about 10, about 9, or about 8 weight percent of the solder composition.

In some embodiments, at least a portion of the flux will have at least one reactive group that can be used to form a covalent bond with at least some of the metal particles. For example, the flux may have carboxylic acid, amide, amine, metal thiolate, and/or ketonate reactive groups. In some examples, the metal particles may be covalently bonded to at least a portion of the flux. It is believed that this bonding improves the properties of the solder composition and might contribute to a reduction in the melting point of the solder composition.

The solder compositions may be provided in any suitable form. For example, the solder compositions may be provided as a solder paste. Solder pastes may be particularly useful in certain electronic and microelectronic processes. The solder paste may be patternable to allow use in microprocessing. In other examples, the solder compositions may be provided as solder balls. These solder balls may additionally be particularly useful in certain electronic and microelectronic processes.

The solder compositions may also exhibit the advantage of having a low initial melting point and a melting point that is elevated after the solder is used to make a connection because the metal particles melt and coalesce. The coalesced particles may exhibit a melting point that is about the same as that of a bulk material of the same composition. Thus, the solder compositions may be useful in step soldering processes in which heat sensitive components may be soldered sequentially and exposed to the heat necessary to melt the solder composition without causing earlier applied components to become damaged or loosen.

The solder compositions may be made in any suitable manner. In some embodiments, the solder compositions are prepare via an in situ preparation method in which the metal particles are formed in the presence of the flux. The in situ preparation method comprises providing a flux in a solvent suitable for dissolving the flux, addition of metal particle precursors to form a flux/metal particle precursor solution, and adding at least one reducing agent to the solution such that metal particles are formed and bonded to the flux.

Any suitable amount of flux may be used. In some examples, the flux may be provided in any suitable amount between about 0.01 g to about 20 grams. Any suitable solvent in any Any suitable metal particle precursor in any suitable amount may be used. For example, the metal particle precursor may comprise a metal salt. Examples of suitable metal salts include, but are not limited to tin chloride, silver nitrate, tin-ethyl hexanoate, silver-ethyl hexanoate, copper nitrate, and/or copper acetate.

It will be understood that the amount of a metal particle precursor may be chosen to provide a desired metal alloy particle. When a tin/silver/copper alloy is formed using tin chloride, silver nitrate, and copper acetate as the metal particle precursors, the tin chloride may comprise from about 2.75 g to about 550 g, the silver nitrate may comprise about 0.05 g to about 14 g, and the copper acetate may comprise from about 0.01 g to about 5 g. When a bismuth/tin alloy is formed using tin chloride and bismuth nitrate as the metal particle precursors, the tin chloride may comprise from about 2.75 g to about 550 g, and the bismuth nitrate may comprise from about 0.35 g to about 68 g.

It will be further understood that any suitable reducing agent may be used in any suitable amount. For example, sodium borohydride may be used, and the sodium borohydride may be provided in an amount from about 0.05 g to about 50 g. Other suitable reducing agents include, but are not limited to tetramethyl ammonium borohydride and ammonium borohydride.

In some embodiments, the metal particle precursors are added to a suitable solvent before they are added to the flux and solvent. For example, a metal particle precursor may be provided in a solvent such as a ketone, alcohol, or water before addition to the flux and solvent solution. For example, in a system comprising flux and methyl ethyl ketone, a tin precursor may be provided in methyl ethyl ketone before addition. In other examples, silver and/or copper precursors may be dissolved in water prior to addition to the flux and solvent. For example, the water may be provided in an amount of about 1 g to about 100 g. In other examples, the water may be provided in an amount between about 1 g to about 20 g.

In some embodiments, additional processing steps may be performed. For example, the flux and metal precursor solution may be sonicated, stirred, and/or heated during or after addition of the reducing agent. For example, the flux and metal precursor solution may be sonicated for any suitable length of time. The solder composition may be further processed after formation. For example, the solder composition may be subject to evaporation or decantation of the solvent to form a solder paste. For example, the solvent may be evaporated by purging nitrogen gas or in a vacuum oven. The composition may also be further processed into another form such as solder balls.

In other embodiments, the metal particles may be formed and subsequently added to a suitable flux. The metal particles may be formed in any suitable manner. For example, the particles may be formed using suitable metal salts in a solution and reducing the salts to form desired particles. Any suitable flux may be added in any suitable manner.

The present invention will be better understood by reference to the following example which are offered by way of illustration not limitation.

### EXAMPLES

### Example 1

### Preparation of Solder Composition Having Tin

0.1 g of Roxin 515-25 Flux is dissolved in 10 ml of methyl ethyl ketone; 11.41 g of tin chloride is added to 35 ml of MEK and 2.3 g of Sodium borohydride is dissolved in 5 ml of water separately and added to the reaction mixture during sonication. The reaction mixture is sonicated for 3-5 minutes. Sonication was conducted at room temperature and atmospheric pressure using a sonicating horn cable of producing oscillations with frequency 20 kHz. The sonicating system is capable of generating 750 watts of power. The solvent is evaporated by purging nitrogen gas with a flow rate of about 40 ml/min or in a vacuum oven at about 40° C. and the solder paste is used for DSC and microstructure studies.

### Example 2

### Preparation of Solder Composition Having Tin/Silver/Copper Alloy

0.1 g Rosin 515-25 Flux is dissolved in 10 ml of methyl ethyl ketone; 27.51 g of tin chloride is added to 35 ml of MEK and added to the reaction mixture. 0.69 g of Silver nitrate is dissolved in 3 ml of water and 0.24 g of copper acetate dissolved in 3 ml of water, 2.3 g of Sodium borohydride is dissolved in 5 ml of water separately. Copper acetate solution is added to the reaction mixture first and then silver nitrate solution, sodium borohydride solution are added to the reaction mixture simultaneously during sonication. The reaction mixture is sonicated for 3-5 minutes. Sonication was conducted at room temperature and atmospheric pressure using a sonicating horn cable of producing oscillations with frequency 20 kHz. The sonicating system is capable of generating 750 watts of power. The solvent is evaporated by purging nitrogen gas with a flow rate of about 40 ml/min or in a vacuum oven at about 40° C. and the solder paste is used for DSC and microstructure studies.

### Example 3

### Preparation of Solder Composition Having Tin/Bismuth Alloy

Tin-Bismuth alloy nanoparticles (90% Sn-10% Bi) are prepared in situ with the flux. Tin chloride (SnCl₂.2H₂O) and bismuth nitrate Bi(NO₃)₃, are used as precursors for tin and bismuth respectively. Sodium borohydride (NaBH₄) is used as a reducing agent. Methyl ethyl ketone (MEK) is used as solvent. 0.1 g of flux is dissolved in 10 ml of methyl ethyl ketone. 17.11 g of tin chloride is added to 35 ml of MEK and added to the reaction mixture. 2.32 g of bismuth nitrate is added to the reaction mixture. 2.3 g of sodium borohydride is dissolved in 5 ml of water separately. Sodium borohydride solution is added to the reaction mixture during sonication. The reaction mixture is sonicated for 3-5 minutes. Sonication was conducted at room temperature and atmospheric pressure using a sonicating horn cable of producing oscillations with frequency 20 kHz. The sonicating system is capable of generating 750 watts of power. The solvent is evaporated by purging nitrogen gas with a flow rate of about 40 ml/min or in a vacuum oven at about 40° C and the solder paste is used for DSC and microstructure studies.

Tin-bismuth alloy particles were prepared without flux. 27.51 g of tin chloride is added to 35 ml of MEK and added to the reaction mixture. 0.69 g of Silver nitrate is dissolved in 3 ml of water and 0.24 g of copper acetate dissolved in 3 ml of water, 2.3 g of Sodium borohydride is dissolved in 5 ml of water separately. Copper acetate solution is added to the reaction mixture first and then silver nitrate solution, sodium borohydride solution are added to the reaction mixture simultaneously during sonication. The reaction mixture is sonicated for 3-5 minutes. Sonication was conducted at room temperature and atmospheric pressure using a sonicating horn cable of producing oscillations with frequency 20 kHz. The sonicating system is capable of generating 750 watts of power. The solvent is evaporated by purging nitrogen gas with a flow rate of about 40 ml/min or in a vacuum oven at about 40° C. and the solder paste is used for DSC and microstructure studies.

### Example 4

### Tin Alloy Nanoparticles Added to Flux

0.11 g of Rosin 515-25 flux is dissolved in 25 ml of MEK and 1 g of Tin alloy nanoparticles, prepared in accordance with the method in Example 3, are added during sonication. The reaction mixture was sonicated for 3 minutes. Sonication was conducted at room temperature and atmospheric pressure using a sonicating horn cable of producing oscillations with frequency 20 kHz. The sonicating system is capable of generating 750 watts of power. The solvent is evaporated by purging nitrogen gas with a flow rate of about 40 ml/min or in a vacuum oven at about 40° C. and the solder paste is used for DSC and microstructure studies.

### Example 5

### Differential Scanning Calorimetry Studies

Heat-flux differential scanning calorimetry (DSC) was applied. In all experiments, when plotting heat flow versus temperature or time, energy taken in by the sample is reported as negative change and energy given off by the sample is reported as a positive change in the heat flow. Thus exothermic events will always result in a peak or shift in the DSC baseline up to more positive heat flow values, while endothermic events will always result in a peak or shift down to more negative values.

A DSC Q100 produced by TA Instruments of Newcastle, Del. was used for all experiments. This device, in its current configuration, is capable of testing at temperatures up to 500° C. under a continuous nitrogen gas purge. The DSC pans used for containing samples and as the inert reference were hermetically sealed aluminum pans. All sample pans were massed before and after a sample was sealed into them to allow the exact mass of each sample to be determined. The DSC was calibrated for the pans and chosen heating rate using as reference the melting temperature of a very pure piece of indium metal provided as a calibration standard by TA Instruments. A heating and cooling rate of 20° C./min was used for all testing.

Samples of flux or nanoparticle-flux combinations were prepared by removing a small amount of sample from its container and then dabbing or dropping a smaller amount of that material into the sample pan. The pans were then sealed, weighed, and placed into the DSC cell alongside a reference. No pinholes were placed in the pans holding a sample, and the pans were left completely sealed throughout testing. This was done to prevent flux or reaction products from depositing on the walls of the DSC during testing and to reduce sample oxidation.

Full calibration of the DSC system was carried out every two to three months. In order to prevent the hermetic seal of the sample pan from being broken due to the pressure of evolved gases, sample sizes were limited to approximately 5 mg or less. In order to characterize the accuracy of the Q100's ability to detect melting, at several points through the course of this work samples from a 99.98% pure tin (Alfa Aesar) were heated from the 40° C. idle temperature of the DSC system to 300° C. and then cooled back to the idle temperature. By comparing the results of these tests to the known 231.9° C. bulk melting temperature of tin the Q100 was when properly calibrated shown to be accurate to within 1 to 1.5° C. depending on the condition of the DSC cell.

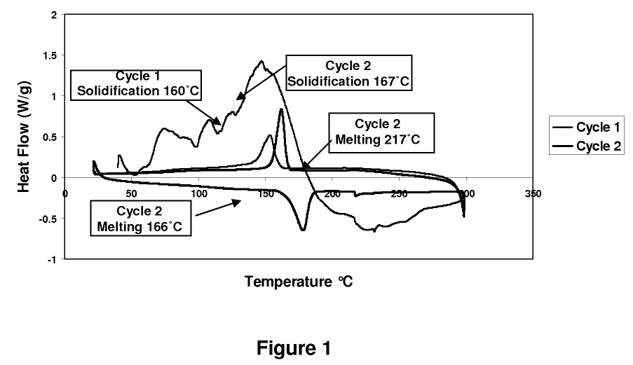

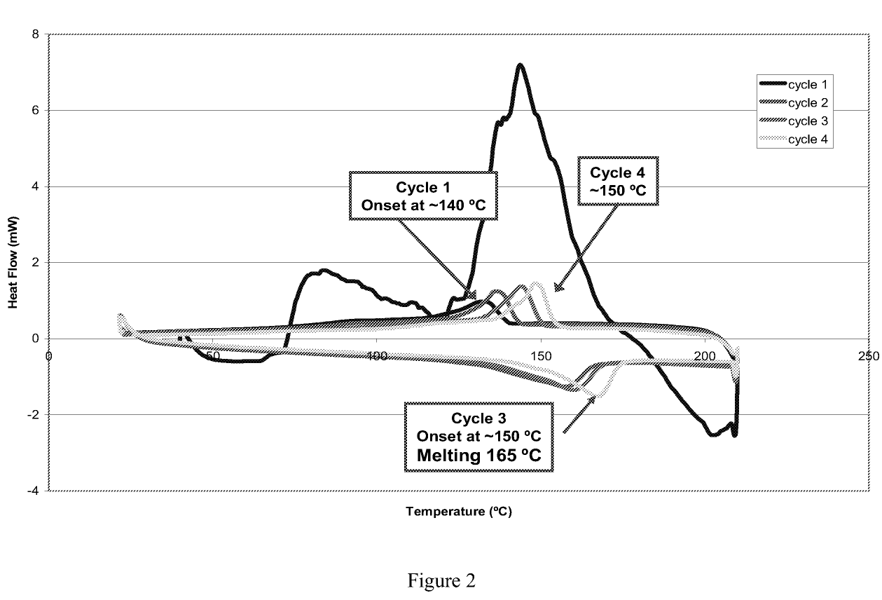

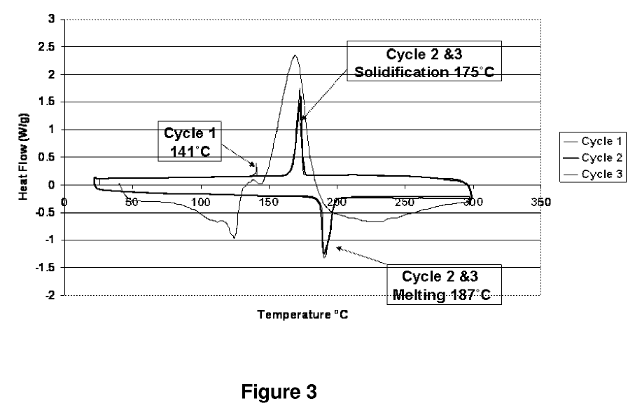

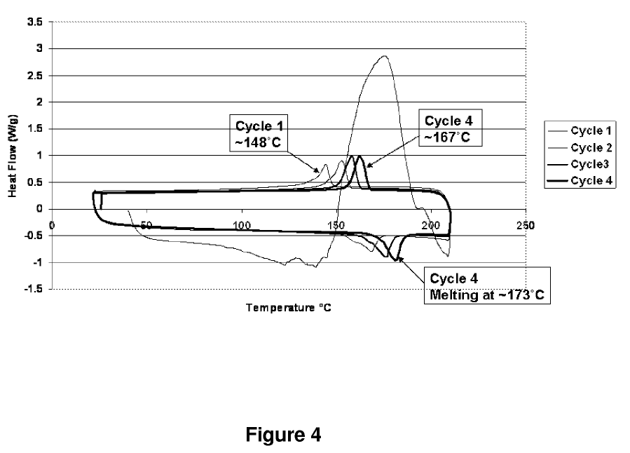

A solder composition having tin/silver/copper alloy particles with a composition of 96.5% tin/3% silver/0.5% Cu was prepared in accordance with the procedure in example 2. The solder composition comprised 91 weight percent metal particles and 9 weight percent Rosin 515-25 flux. FIG. 1 shows a DSC plot obtained using 3 heating cycles to 300° C. FIG. 2 shows a DSC plot obtained using 4 cylces of heating to 210° C. with a 5 minute hold at temperature. A solder composition having 92 weight percent tin particles and 8 percent Rosin 515-25 flux prepared in accordance with the procedure in example 1 was analyzed. FIG. 3 shows a DSC plot obtained using 3 heating cycles to 300° C. FIG. 4 shows a DSC plot obtained using 4 heating cycles to 210° C. with a 5 minute hold at temperature.

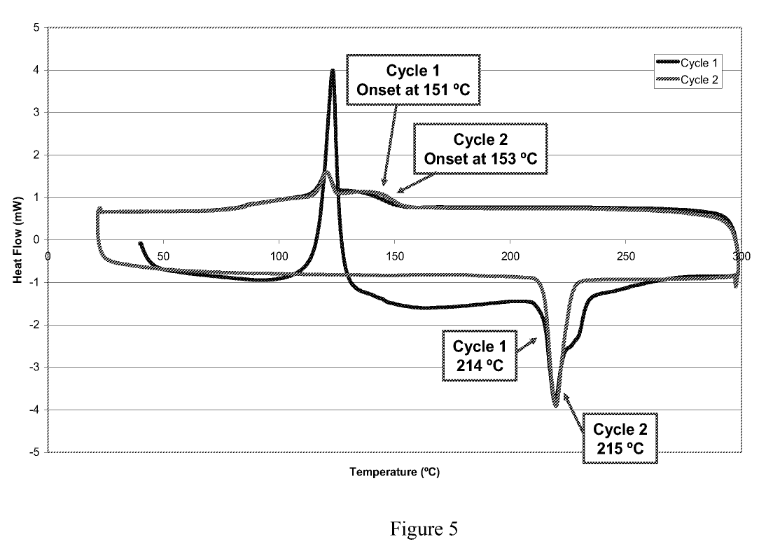

FIG. 5 shows a DSC plot obtained using 2 heating cycles to 300° C. and cooling down to 20° C. of a tin alloy composition added to flux and prepared in accordance with Example 4.

The present invention should not be considered limited to the specific example described above, but rather should be understood to cover all aspects of the invention. Various modifications, equivalent processes, as well as numerous structures and devices to which the present invention may be applicable will be readily apparent to those of skill in the art.

It will be obvious to those skilled in the art that various changes may be made without departing from the scope of the invention, which is not to be considered limited to what is described in the specification.

What is claimed is:

1. A solder composition, comprising:
a plurality of metal particles, wherein the plurality of metal particles have an average diameter of less than about 100 nm; and
a flux, wherein the flux is selected such that the flux has at least one reactive group suitable for covalent bonding with at least one of the metal particles, and wherein at least one of the metal particles is covalently bound to the flux.

2. The solder composition as claimed in claim 0 wherein the plurality of metal particles has an average diameter of less than about 50 nm.

3. The solder composition as claimed in claim 0 wherein the plurality of metal particles has an average diameter of less than about 20 nm.

4. The solder composition as claimed in claim 0 wherein the plurality of metal particles comprise a metal alloy.

5. The solder composition as claimed in claim 4 wherein the average diameter of the metal particles and the metal alloy is selected such that the solder composition melts at a desired temperature.

6. The solder composition as claimed in claim 0 wherein the solder composition comprises a lead free solder.

7. The solder composition as claimed in claim 0 wherein the solder composition melts at a temperature of less than about 190° C.

8. The solder composition as claimed in claim 0 wherein the metal particles comprise tin, copper, and silver.

9. The solder composition as claimed in claim 0 wherein the metal particles comprise an alloy selected from tin/silver/copper alloys, bismuth/indium/tin alloys, bismuth/tin/antimony alloys, bismuth/tin/aluminum alloys, tin/bismuth alloys, tin/antimony alloys, tin/gold alloys, tin/indium alloys, and combinations thereof.

10. The solder as claimed in claim 0, wherein the metal particles comprise tin.

11. The solder as claimed in claim 0, wherein the flux has at least one reactive group selected from carboxylic acid groups, amide groups, and combinations thereof.

12. The solder as claimed in claim 0, wherein the flux is selected from Rosin 515-25, Rosin 541-70, Rosin 541-71, and combinations thereof.

13. The solder as claimed in claim 0, wherein the flux comprises Rosin 515-25, and wherein the metal particles comprise a tin/copper/silver alloy.

14. A method of making solder, comprising:
providing a flux in a suitable solvent, wherein the flux is selected such that the flux has at least one reactive group;
adding at least one metal particle precursor to form a mixture; and
adding at least one reducing agent to the mixture such that metal particles are formed and at least one of the metal particles is bonded to the flux by the at least one reactive group, wherein the metal particles have an average diameter of less than about 100 nm.

15. The method as claimed in claim 14, wherein the metal particles have an average diameter of less than about 50 nm.

16. The method as claimed in claim 14, wherein the metal particle precursor comprises a metal salt.

17. The method as claimed in claim 16, wherein the metal salt is selected from a tin, silver, copper, aluminum, bismuth, antimony metal salt, and combinations thereof.

18. The method as claimed in claim 14, wherein the reducing agent is selected from sodium borohydride, tetramethyl ammonium borohydride, ammonium borohydride and combinations thereof.

19. The method as claimed in claim 14, further comprising the step of sonicating the mixture after adding the at least one reducing agent.

20. The method as claimed in claim 14, further comprising processing the metal particles and flux such that a solder paste is produced.

21. A solder composition made by the method claimed in claim 14.
